(19) United States
(12) Patent Application Publication
(10) Pub. No.: US 2012/0227880 A1
(43) Pub. Date: Sep. 13, 2012

(54) ANTI-SKID SPIKE

(76) Inventors: Frédéric Michel Jean Pons, Thionville (FR); Sébastien Morin, Tellancourt (FR); Xavier Sébastien Benoit Fraipont, Ochain-Clavier (BE); Stefan Roth, Aichhalden (DE)

(21) Appl. No.: 13/395,454

(22) PCT Filed: Sep. 6, 2010
(86) PCT No.: PCT/EP2010/063007

§ 371 Date: May 15, 2012

(30) Foreign Application Priority Data
Sep. 23, 2009 (DE) 10 2009 042 720.1

(51) Int. Cl. B60C 27/00

(52) U.S. Cl. 152/208

(57) ABSTRACT

The invention relates to an anti-skid stud for a tire having a supporting part (10) and an insert (20) which is secured thereto, wherein the supporting part (10) has a flange section (14) to which a securing section (15), into which a receptacle (19) is integrally formed, is connected, wherein the insert (20) is inserted into the receptacle (19) and projects with a head (22) out of the receptacle (19). In such anti-skid studs, particularly good grip is achieved which remains the same independently of the positional orientation in the tire by virtue of the fact that the head (22) of the insert (20) has a hexagonal cross section at least in certain areas.

The invention relates to an anti-skid spike for a tire with a bearing part and an insert held thereon, wherein the bearing part has a flange section, to which a retaining section is connected, in which a receptacle is shaped, wherein the insert is inserted into the receptacle and projects out of the receptacle with a head.

An anti-skid spike of this type is known from DE 19 03 668. A bearing part is used thereby, which has a flange section as an anchoring foot. A cylindrical retaining section is shaped on the anchoring foot. A receptacle is sunk in the retaining section in the manner of a blind hole, in which receptacle an insert of hard material, preferably a hard metal spike, is held. The insert projects with a head out of the receptacle, wherein the head can be square, round or triangular in cross section. The head forms the functional element, which in winter operation penetrates into the snow layer or ice layer lying on the road surface in order to achieve an improved non-skid property. In practice anti-skid spikes have become established with inserts that have a round head in cross section. The inserts with square or triangular cross section have a good non-skid property, since the edge sections of the head support a good penetration into the snow covering or ice covering. This effect is achieved primarily when the head cross section in the position of its edges is aligned exactly to the tire. This alignment is difficult to achieve during assembly, and the anti-skid spikes twist with respect to the tire during operational use. However, the advantage of the improved non-skid property is then no longer given. It has furthermore been shown that the square or triangular cross sections have an unfavorable wear behavior under certain road conditions and then wear out excessively fast.

From SE 523 713 C2 an anti-skid spike is known which has a similar design to that according to DE 19 03 668. As insert a hard metal pin is used thereby, which has a pentagonal cross section. Here, too, there is the problem that an exact anti-skid alignment is necessary. In order to circumvent this disadvantage, SE 523 713 C2 suggests arching the edges of the head section in a concave manner in order to achieve a better edge grip, regardless of the spatial orientation. Furthermore, seven-sided cross-sectional shapes are proposed, which then, however, again are close to the round cross section and do not offer any substantially improved non-skid property compared to them, so that the necessary additional expenditure is not justified for the manufacturer.

The object of the invention is to provide an anti-skid spike of the type mentioned at the outset which is characterized by an improved non-skid property even when it is assembled regardless of position.

This object is attained in that the head of the insert has a hexagonal cross section at least in some regions.

It has been shown that with this cross sectional shape approximately the same non-skid property values are always achieved regardless of the arrangement of the head and its orientation with respect to the driving direction. This results in a clear advantage in terms of assembly. It has furthermore surprisingly been shown that the hexagonal cross-sectional geometry has an improved non-skid property compared to the known anti-skid spikes, in particular the lateral stability in cornering is markedly improved.

According to a preferred embodiment of the invention it is provided that the hexagonal cross section of the head is formed by surfaces parallel to one another in pairs, wherein the parallel surfaces have a distance measurement from one another which is in the range between 1.8 and 2.8 mm, preferably between 2.2 mm and 2.4 mm, for example 2.3 mm. This cross-sectional design renders possible an aggressive penetration into the snow covering /ice covering during the rolling operation. At the same time, however, seen perpendicular to the cross-sectional plane, a projection surface is also created that is particularly suitable dimensioned for lateral stability.

For uniform non-skid property values it is advantageous that the hexagonal cross section is embodied symmetrically and all of the surfaces have the same extension in the cross-sectional plane.

When the anti-skid spike is such that the corners of the hexagonal cross section are formed by rounded transitional sections, then on the one hand a wear-optimized design of the edges is achieved. On the other hand, a successive edge grip is promoted during the rolling of the tire.

A particularly preferred variant of the invention is that a shank is shaped on the head of the insert and that the hexagonal cross section of the head continuously flows into a bridging region of the shank. The stresses introduced into the head can be continuously absorbed via the bridging region so that no inadmissible stress peaks are produced. It is conceivable that the shank has a conical section or is embodied in a conical manner. The shank can then be accommodated with its cone region in a cone receptacle of the bearing part in a non-positive manner. The cone angle is thereby to be dimensioned such that there is a self-retention.

If it is provided that the head of the insert is finished by a ball indentation-shaped cap section arched in a convex manner, the penetration behavior of the anti-skid spike is improved and the positional stabilization thereof is achieved during the rolling of the tire. Furthermore, an improved wear behavior is produced since the edge grip of the head takes place continuously.

The anti-skid spike according to the invention is characterized by a particular non-skid property. In order to be able thereby to reliably dissipate the forces occurring during operation without the insert being detached, it can be provided that the insert projects out of the receptacle in the range between 1.0 mm and 1.4 mm, preferably 1.1 mm to 1.3 mm, particularly preferably 1.2 mm and is fixed in the receptacle in the axial direction of the insert over a holding length of at least 4.5 mm. A secure anchoring and force dissipation in the tire is caused in that the flange section forms a first diameter, that the retaining section has a section that has a second diameter, and that the diameter ratio of the first diameter to the second diameter is selected in the range between 1.3 and 1.8, preferably 1.4 to 1.6, preferably 1.52.

A secure anchoring of the bearing part can be achieved in particular when the flange section has a first diameter≧7.5 mm.

A stable design, which is also optimized in terms of weight results, for example, in that the bearing part has an end piece on its end facing away from the flange section, which end piece forms a circular cross section, that the circular cross section of the end piece has a third diameter and that the diameter ratio of the first diameter of the flange section to the third diameter is selected in the range between 1.1 and 1.5, preferably 1.2 to 1.4, for example 1.3, and/or that the diameter ratio of the second diameter of the retaining section to the third diameter of the end section is selected in the range between 0.75 and 0.95, preferably 0.83 and 0.89, for example 0.857.

The insert is sufficiently securely anchored in the bearing part in particular when it is provided that the bearing part has a total longitudinal extension in the axial direction in the range between 8.0 mm and 12.0 mm, preferably 9.7 to 10.1 mm and that the insert has a length in the axial direction of the bearing part which is selected in the range between 4 mm and 7.5 mm, for example, 6.3 mm.

In order to safely prevent a deformation or a fracture of the flange section with high stresses, an anti-skid spike according to the invention can be such that the flange section has a height in the axial direction of the bearing part in the range between 1.0 mm and 2.2, preferably 1.5 mm to 1.7 mm.

A further anti-skid spike according to the invention can be such that the ratio of the total longitudinal extension of the bearing part to the maximum diameter of the flange section is selected in the range between 1.1 and 1.3. With this design, the bending stress introduced via the insert is safely dissipated into the tire.

A preferred variant of the invention is such that the bearing part and the insert together have a mass≧1.1 g.

The invention is explained in more detail below based on an exemplary embodiment shown in the drawings.

They show:

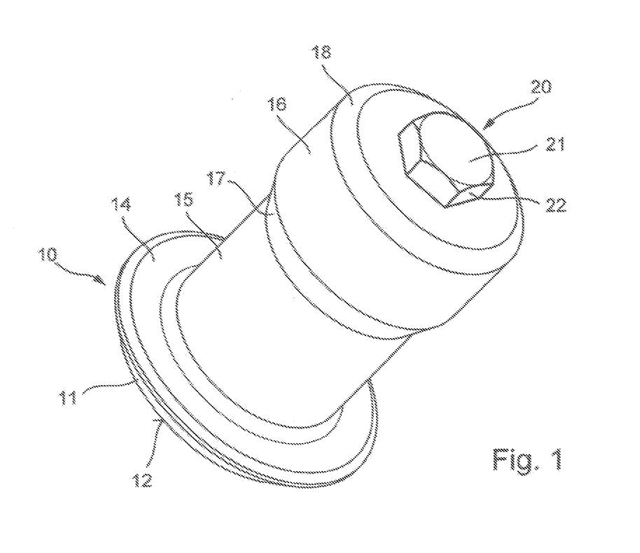

FIG. 1 an anti-skid spike in perspective representation,

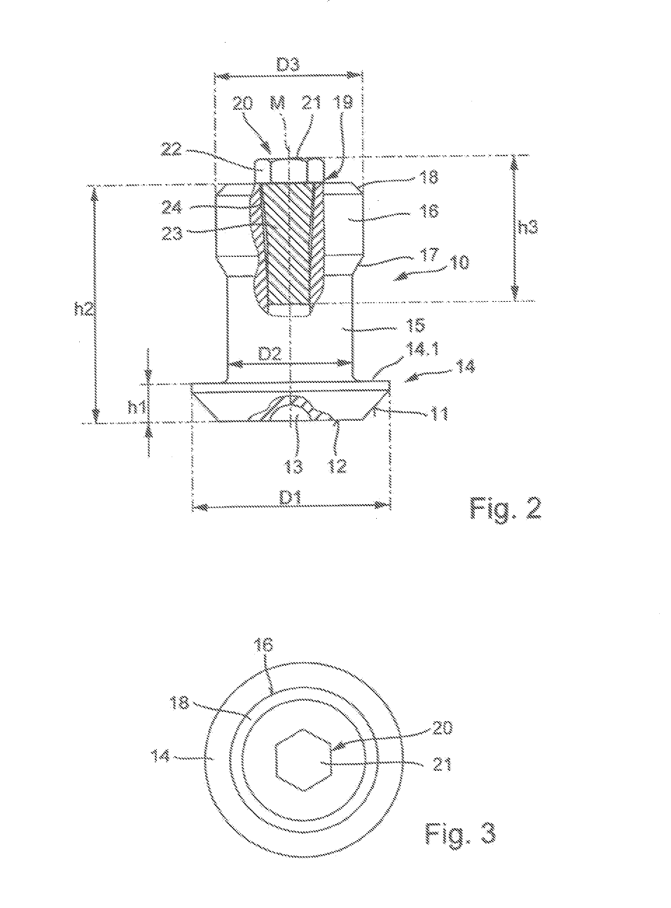

FIG. 2 the anti-skid spike according to FIG. 1 in side view and partially in section and

FIG. 3 the anti-skid spike according to FIGS. 1 and 2 in plan view.

FIG. 1 shows an anti-skid spike with a bearing part 10, which is produced as a metal cast part, in particular as an aluminum cast part.

As FIG. 2 shows more clearly, the bearing part 10 has a flange section 14 embodied as an anchoring foot, which forms a lower flat support surface 12, into which a trough 13 is worked for reasons of weight reduction.

An annular peripheral sloping surface 11 adjoins the support surface 12 at an angle. The sloping surface 11 merges into a shoulder 14.1 via a curvature section, which shoulder is oriented perpendicular to the center longitudinal axis M of the anti-skid spike.

As FIG. 3 shows, the shoulder 14.1 runs in an annular manner about the center longitudinal axis M. The flange section 14 itself is embodied in the shape of a truncated cone and has a maximum first diameter D1 (for example≧7.5 mm, in this case 8.2 mm). In the region of the shoulder 14.1 a retaining section 15 is shaped on the flange section 14. The retaining section 15 has a cylindrical center region with a second diameter D2 (for example, in the range between 5.0 and 5.8 mm, preferably 5.2 and 5.6 mm, in this case 5.4 mm). At the free end of the bearing part 10 the retaining section 15 forms a thickened end piece 16 with a diameter D3, wherein the center region is bridged to the end piece 16 via a support section 17 running tilted to the center longitudinal axis M. The end piece 16 is finished with a peripheral chamfer 18. The diameter D3 is between 5.9 mm and 6.7 mm, preferably 6.1 mm and 6.5 mm, particularly preferably 6.3 mm.

A receptacle 19 is worked into the bearing part 10, in which receptacle an insert 20 is attached. The insert 20 is embodied as a hard metal spike. It has a shank 23, on which a head 22 is shaped. The head 22 has a hexagonal cross section and is finished with a cap section 21 arched in a convex manner.

The cross-sectional shape of the head 22 is bridged into the shank 23, wherein a bridging region 24 is formed, in which the edges of the head 22 flow continuously in the shank 23.

The free shank end facing away from the head 22 is then embodied in a circular manner in cross section. The receptacle 19 is dimensioned such that the insert 20 can be pressed in. Material of the bearing part 10 that is forced out thereby flows into the free cross-sectional regions between the receptacle 19 and the shank 23. In this manner a secure anchoring of the insert 20 is ensured.

1. An anti-skid spike for a tire with a bearing part (10) and an insert (20) held thereon, wherein the bearing part (10) has a flange section (14), to which a retaining section (15) is connected, in which a receptacle (19) is shaped, wherein the insert (20) is inserted into the receptacle (19) and projects out of the receptacle (19) with a head (22), characterized in that the head (22) of the insert (20) has a hexagonal cross section at least in some regions.

2. The anti-skid spike according to claim 1, characterized in that the hexagonal cross section of the head (22) is formed by surfaces parallel to one another in pairs, wherein the parallel surfaces have a distance measurement from one another which is in the range between 1.8 mm and 2.8 mm.

3. The anti-skid spike according to claim 2, characterized in that the hexagonal cross section is embodied symmetrically and all of the surfaces have the same extension in the cross-sectional plane.

4. The anti-skid spike according to one of claims 1 through 3, characterized in that the corners of the hexagonal cross section are formed by rounded transitional sections.

5. The anti-skid spike according to one of claims 1 through 4, characterized in that a shank (23) is shaped on the head (22) of the insert (20) and that the hexagonal cross section of the head (22) continuously flows into a bridging region (24) of the shank (23).

6. The anti-skid spike according to one of claims 1 through 5, characterized in that the head (22) of the insert (20) is finished by a ball indentation-shaped cap section (21) arched in a convex manner.

7. The anti-skid spike according to one of claims 1 through 6, characterized in that the insert (20) projects out of the receptacle (19) in the range between 1.0 mm and 1.4 mm and is fixed in the receptacle (19) in the axial direction of the insert (20) over a holding length of at least 4.5 mm.

8. The anti-skid spike according to one of claims 1 through 7, characterized in that that the flange section (14) forms a first maximum diameter (D1), that the retaining section (15) has a section that has a second diameter (D2), and that the diameter ratio of the first diameter (D1) to the second diameter (D2) is selected in the range between 1.2 and 1.7.

9. The anti-skid spike according to one of claims 1 through 8, characterized in that the bearing part (10) has an end piece (16) on its end facing away from the flange section (14), which end piece forms a circular cross section, that the circular cross section of the end piece (16) has a third diameter (D3) and that the diameter ratio of the first diameter (D1) of the flange section (14) to the third diameter (D3) (D1:D3) is selected in the range between 1.1 and 1.5, and/or that the diameter ratio of the second diameter (D2) of the retaining section (15) to the third diameter (D3) (D2:D3) of the end section (16) is selected in the range between 0.75 and 0.95.

10. The anti-skid spike according to one of claims 1 through 9, characterized in that the bearing part (10) has a total longitudinal extension (h1) in the axial direction in the range between 8.0 mm and 12.0 mm and that the insert (20) has a length (h3) in the axial direction of the bearing part (10) which is selected in the range between 4 mm and 7.5 mm.

11. The anti-skid spike according to one of claims 1 through 10, characterized in that the flange section (14) has a height (h1) in the axial direction of the bearing part (10) in the range between 1.0 mm and 2.2 mm.

12. The anti-skid spike according to one of claims 7 through 11, characterized in that that the ratio of the total longitudinal extension (h1) of the bearing part (10) to the maximum diameter (D1) (h1:D1) of the flange section (14) is selected in the range between 1.1 and 1.3.

13. The anti-skid spike according to one of claims 1 through 12, characterized in that the bearing part (10) and the insert (20) together have a mass≦1.1 g.

14. A tire with an anti-skid spike, wherein the anti-skid spike is anchored in a receptacle of the tire, characterized by an anti-skid spike according to one of claims 1 through 13.
